(19) United States
(12) Patent Application Publication
(10) Pub. No.: US 2008/0203619 A1
(43) Pub. Date: Aug. 28, 2008

(54) Non-Porous Polyvinylidene Fluoride (Pvdf) Films in the Beta Phase and Processing Method Thereof

(75) Inventors: Senentxu Lanceros-Mendez, Braga (PT); Vitor Joao Gomes Da Silva, Povoa De Varzim (PT); Rinaldo Gregorio Filho, Sao Paulo (BR)

Correspondence Address: SUGHRUE MION, PLLC, 2100 PENNSYLVANIA AVENUE, N.W., SUITE 800, WASHINGTON, DC, 20037, US

(73) Assignee: Universidade Do Minho, Braga (PT)

(21) Appl. No.: 11/996,165

(22) PCT Filed: Jul. 19, 2006
(86) PCT No.: PCT/IB06/52474

§ 371 Date: Jan. 18, 2008

(30) Foreign Application Priority Data
Jul. 19, 2005 (PT) 103318

(51) Int. Cl. B29C 41/00

(52) U.S. Cl. 264/435

(57) ABSTRACT

The invention reports a new film of the beta phase of polyvinylidene fluoride (PVDF) and its processing for the elimination of porosity, using a compression force along the thickness direction of the sample at a high temperature. The join action of the compression force and the temperature eliminates the porosity of the PVDF beta phase, improving its mechanical (Young's modulus, yielding and breaking stress, yielding and breaking strain), electrical (dielectric constant, electric rupture) and electromechanical properties (electromechanical coupling, piezoelectric coefficients) and, therefore, the use of the material in technological applications. Non-porous material, 95 to 100% in beta phase and with crystallinity degrees higher than 50%, is obtained

### TECHNICAL DOMAIN OF THE INVENTION

The invention refers to a film of the PVDF beta phase and a processing method, which goal is the elimination of the porosity of the material, improving in this way the mechanical, electrical and electromechanical properties. The material obtained by the method here presented comprises 95 to 100% of beta phase and a crystallinity degree higher that the one observed up to now.

### BACKGROUND OF THE INVENTION

Polyvinylidene fluoride, PVDF, is a polymer with interesting pyroelectric and piezoelectric properties, turning it into a material with important electro-optical, electromechanical and biomedical applications.

This polymer shows at least four different crystalline phases, however, the one with the best pyroelectric and piezoelectric properties, after poling, is the beta phase. Until recently, this phase was only obtained by mechanical stretching of films primarily in the non-polar alpha phase, the most easily obtained. This process resulted in films pre-dominantly in the beta phase, but still with amounts of alpha phase between 10 and 20%.

Non-oriented films and containing exclusively beta phase, were obtained from crystallisation of PVDF from solution with dimethylformamide (DMF) or dimethylacetamide (DMA) at temperatures below 70° C. (1). On the other hand, the films obtained by this method present a high degree of porosity (around 60%; FIG. 1), which makes them opaque (milky) and fragile, beside prejudicing its electrical properties and not allowing the poling of the film.

There are several patents referring to applications of the porous beta-phase. The patents that follow refer to the construction of products having as base the pores of the PVDF beta-phase. Patent EP 0 888 211 B1 reports the construction of a porous membrane, patent CA 2 244 180 reports a different method for obtaining porous membranes and patent US 2004/0256310 A1 reports the construction of a porous and water-proof membrane.

The advantages in obtaining this product without pores in the beta phase consist in:
improvement of the mechanical and electrical properties, which are heavily reduced with increasing porosity;
improvement of the electroactive properties (piezo-, pyro- and ferro-electricity), useful for many applications and related to the amount of beta phase.

### BRIEF DESCRIPTION OF THE FIGURES

FIG. 1 Photography of the film obtained from solution, showing the transparent circular region that suffered the pressure.

FIG. 2 Scanning Electron Micrography (SEM) of the surface of the film obtained from solution with DMF at 60° C.

FIG. 3 SEM of the fractured region of the film.

FIG. 4 SEM of the fractured region of the film after pressing.

FIG. 5 FTIR spectra of the film before (a) and after pressing (b).

FIG. 6 DSC curves of the film before (a) and after pressing (b).

### DETAILED DESCRIPTION OF THE INVENTION

The present invention describes the PVDF film and a processing method that leads to obtaining the PVDF beta phase without pores, with increase of the crystalline fraction and improvement of the mechanical, electrical and electromechanical properties of the material.

Currently, the non-porous films in the beta phase are obtained by mechanical stretching form the non-polar alpha phase, but the material processed in this way still shows a small amount of material in the alpha phase.

Non-oriented films and containing exclusively the beta phase are obtained by crystallisation of PVDF from solution with dimethylformamide (DMF) or dimethylacetamide (DMA) at temperatures below 70° C. (1). These films show a high degree of porosity, which is at the origin of the patents mentioned before.

According to a first essential aspect, the present invention refers to a method for the preparation of films in the beta phase, including:
(a) solution of PVDF in DMF or DMA for obtaining the film from solution at temperatures below 70° C.; characterised by the fact that the film obtained in (a) is subjected to another processing step that includes:
(b) pressure appliance on the film in the presence of heat.

According to a preferred embodiment, the pressure is applied along the thickness direction and is higher than 7.5×10⁶ Pa.

According to another preferred embodiment in accordance with the present invention, the temperature of step (b) is comprised between 140 and 160° C.

According to another preferred embodiment in accordance with the present invention, the time, during which pressure is applied in the presence of heat in step (b), is more than 5 minutes.

According to a second essential aspect, the present invention refers to PVDF films with an amount of beta phase comprised between 95 and 100%, relatively to the total weight of the film, characterised for not having pores in its structure.

According to a preferred embodiment in accordance with the invention, the PVDF films are oriented by stretching with deformations higher than 100%.

According to another preferred embodiment, the PVDF films are poled in electric fields higher than 60 MV/m.

According to another preferred embodiment, the relative dielectric permittivity is in the range of 7 to 13, depending on the processing conditions.

According to another preferred embodiment in accordance with the present invention the Young modulus is in the range of 1-4 10⁹ N/m², depending on the processing conditions.

According to another preferred embodiment in accordance with the present invention the piezoelectric coefficients d is in the range of −20 to −35 μC/N and d is in the range of 17 to 25 μC/N, depending on the processing conditions and the state and method of polarization.

According to another preferred embodiment in accordance with the present invention, the degree of the film is higher than 50%.

According to a third essential aspect, the present invention refers to the use of the film, in accordance with the present invention, in electro-optical, electromechanical and biomedical applications.

### Description of the Method for Elimination of the Porosity

The beta-PVDF films obtained directly from solution present an elevated degree of porosity⁽¹⁾. This porosity impedes the poling of the films and therefore hindering their utilisation in technological applications involving piezo-, pyro- and ferroelectric properties. Furthermore, the mechanical and dielectric properties are severely reduced due to the presence of pores.

For example, the porous films show a fragile breaking at deformations lower than 50%, whereas the non-porous samples allow deformations higher than 500% and therefore the orientation of the films. This is advantageous from the point of view of technological applications.

The dielectric constant of the porous material is formed by the response of the material plus the pores, leading to large frequency dispersion and to relative dielectric permittivity values lower than the values obtained for the non-porous sample (5 vs. 8 at 1 kHz).

Finally, the fact that porous samples cannot be poled, hinders its utilisation in the scope of technological applications that involve the use of the piezo-, pyro- and ferroelectric effects. These effects are not measurable in the porous samples, while the values obtained for the non-porous samples are similar or higher than the ones obtained for the samples prepared by stretching from the alpha-PVDF.

Films with thickness between 20 and 30 mm were obtained by spreading a solution of PVDF (FORAFLON 4000HD-Atochem Co) in N,N-dimethylformamide (DMF-Merk) on a glass substrate. The initial weight concentration of the solution was 20% of PVDF. The total evaporation of the solvent was performed at 60° C. for 60 minutes. The film was then removed from the substrate and suffered a pressure of 1.5×10⁷ Pa at 150° C. for 10 minutes in a hydraulic press. Infrared spectra (FTIR) of the film, before and after pressing, were obtained by a spectrophotometer Perkin-Elmer Spectrum 1000. Differential scanning calorimetry analyses (DSC) were performed using a Perkin-Elmer at a heating rate of 10° C./minute. They were obtained by Scanning Electron Microscopy (SEM) by a Phillips XL30 FEG electronic microscope.

### Features of the Obtained Beta-PVDF Films

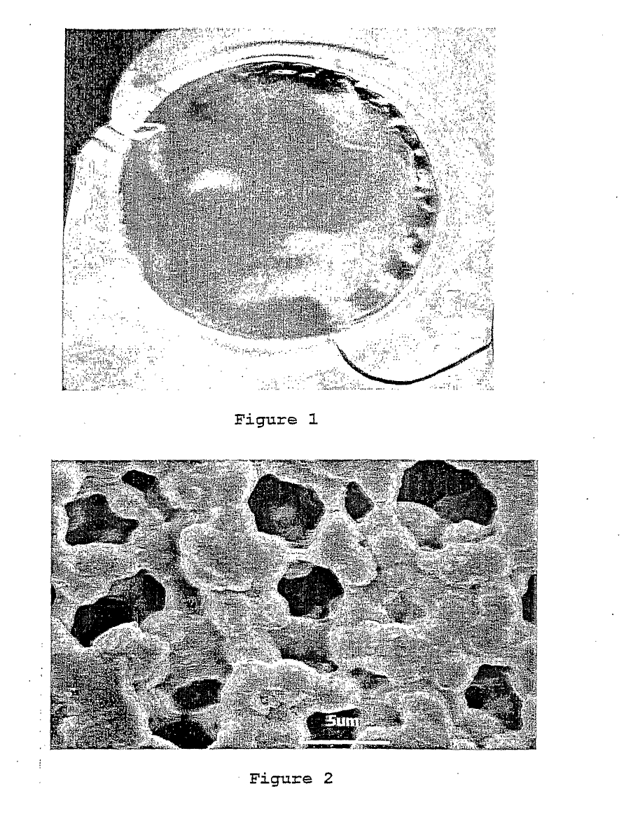

FIG. 1 shows a photography of the film obtained from crystallisation from solution at 60° C. Under these conditions, the film crystallises exclusively in the beta phase⁽¹⁾, but with a high degree of porosity that turns the film opaque (milky) and fragile. This milky aspect, evident in FIG. 1, is caused by the cavities between the spherulites, which produce solid/air interfaces that reflect and refract the visible radiation, and even the infrared radiation, in the range between 900 and 4000 cm⁻¹, causing an inclination in the base-line of the spectra. In the centre of the film, the circular region where the pressure was applied can be observed. In this region the film is transparent and posses an excellent flexibility.

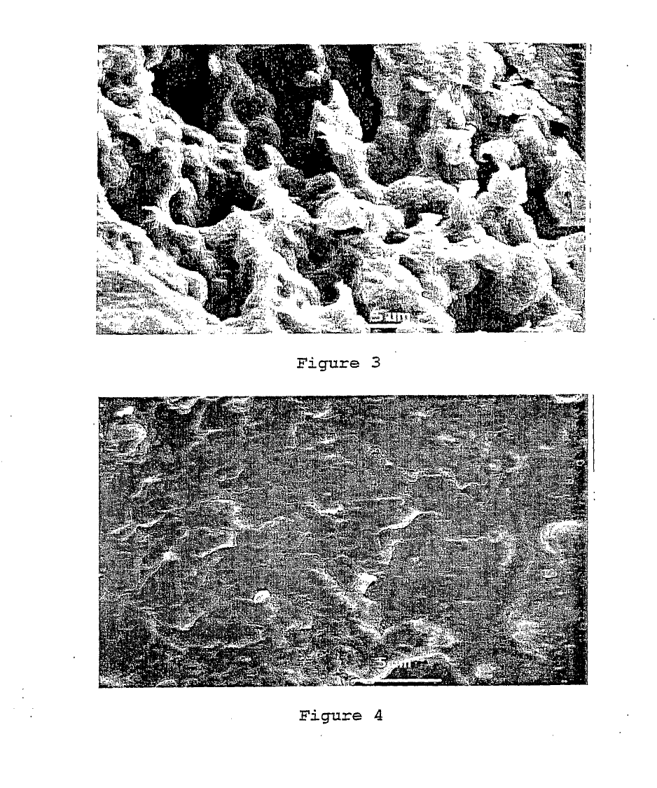

The cavities between the spherulites, which cause the elevated porosity, can be observed in FIG. 2, a SEM micrograph of the surface of the film before the application of pressure. FIGS. 3 and 4, respectively, show a fractured region of the film before and after pressing. Here is evident the strong reduction of the porosity of the sample. The film was fractured after being immersed in liquid nitrogen.

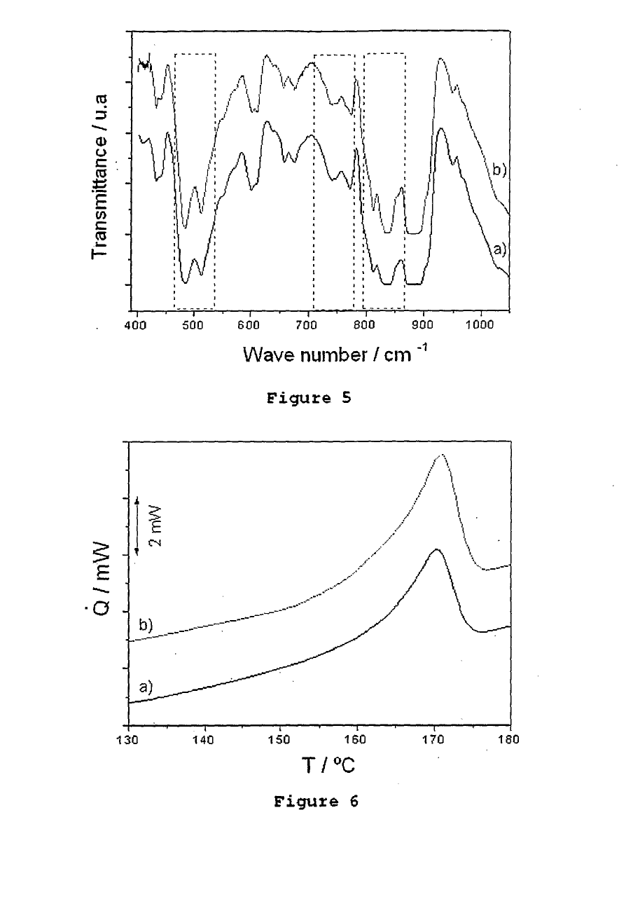

FIG. 5 shows FTIR spectra of the sample before (a) and after (b) pressing. In both cases can be observed, through the bands at 510 and 840 cm⁻¹, that the material processed by this method presents exclusively the -beta phase. This shows that the pressing procedure does not change the crystalline phase present in the sample, merely reducing its thickness.

FIG. 6 shows the DSC thermographs of the sample, before (a) and after (b) pressing. A small increase of the value of the enthalpy of fusion after pressing can be observed, which indicates a slight increase in the degree of crystallinity of the sample.

The dielectric, pyro- and piezoelectric properties and the hysteresis curve of these films, exclusively in the beta phase and non-porous, allow several technological applications.

### BIBLIOGRAPHIC REFERENCES

⁽¹⁾R. Gregorio Filho; M. Cestari J. Polym. Sci: Part B: Polym. Phys. 1994, 32, 859.

1. A method for the preparation of films in the beta phase, comprising:
(a) obtaining PVDF film by DMF or DMA at temperatures below 70° C.;
(b) application of pressure on the film along the thickness direction higher than 7.5×10⁶ Pa at temperatures in the range of 140 to 160° C.

2. Method according to claim 1, wherein the pressure is applied along the thickness direction and being higher than 7.5×10⁶ Pa.

3.-4. (canceled)

5. A PVDF film according to the method of claim 1, with an amount of beta phase comprised between 95 and 100%, relatively to the total weight of the film, wherein there are no pores in its microscopic structure.

6. Method according to claim 1, wherein the PVDF film is oriented by stretching with deformations higher than 100%.

7. Method according to claim 1, wherein the PVDF film is poled in electric fields higher than 60 MV/m.

8. PVDF film according to method claim 1, having a relative dielectric permittivity of 7 to 13.

9. PVDF film according to method claim 1, having a Young modulus in the range of 1-4 10⁹ N/m².

10. PVDF film according to method claim 1, having piezoelectric coefficients d₃₃ in the range of −20 to −35 pC/N and d₃₁ in the range of 17 to 25 μC/N.

11. PVDF film according to method claim 1, wherein the degree of crystallinity is higher than 50%.

12. Use of a film according to claim 1, wherein the film is used in electro-optical, electromechanical and biomedical applications.
